(19) United States
(12) Patent Application Publication
(10) Pub. No.: US 2007/0276724 A1
(43) Pub. Date: Nov. 29, 2007

(54) PAY STATION

(76) Inventor: Gary Arthur Catt, Vancouver (CA)

Correspondence Address: Gary Arthur Catt, 15 East 3rd Avenvue, Vancouver, BC, V5T 1C5, US

(21) Appl. No.: 11/747,834

(22) Filed: May 11, 2007

Related U.S. Application Data
(60) Provisional application No. 60/747,120, filed on May 12, 2006.

(51) Int. Cl. G07B 15/00; G07B 15/02

(52) U.S. Cl. 705/13

(57) ABSTRACT

There is provided a pay station apparatus for parking comprising an enclosure having a plurality of sides, means for controlling operation of the pay station, means for selecting a payment configured with the means for controlling and the enclosure, means for accepting the payment configured with the means for controlling and the enclosure, and a first energy absorbing side panel connected with at least one of the sides of the enclosure.

### CROSS-REFERENCE TO RELATED APPLICATIONS

This application claims the benefit of the previously filed U.S. Provisional Application No. 60/747,120, filed by Gary Arthur Catt on May 12, 2006.

### BACKGROUND OF THE INVENTION

1. Field of the Invention

The present invention relates to a pay station, e.g. a pay station to pay for parking, and more particularly to the enclosure of the pay station.

2. Description of the Related Art

Conventional pay stations for parking are used for on-street and off-street parking, and therefore are in close proximity to the movement of vehicles and susceptible to damage from collision. An enclosure of the pay station is typically made from metal. Peripheral devices and electronics used in the pay station are typically secured with the enclosure. Any shock or vibration resulting from such a collision is instantly transferred to the peripheral devices possibly resulting in irreparable damage.

U.S. Pat. No. 6,929,179, issued Aug. 16, 2005 to Fulcher et al., discloses an automated fee collecting and parking ticket dispensing machine having a protective housing (4) on top of a pedestal (60). The protective housing (4) encloses peripheral devices such as a bill acceptor (18) and a coin acceptor (68).

U.S. Pat. No. 7,029,167, issued Apr. 18, 2006 to Frederick L. Mitschele, discloses a parking meter which includes a microcontroller and a timer coupled with a microcontroller. A mechanism for accepting payment by coin, credit card or both is coupled with the microcontroller for accepting payment for use of an associated parking space. The microcontroller initiates the timer for a prepaid parking interval upon receiving a signal from the payment acceptance mechanism. A vehicle detector is coupled with the microcontroller for detecting the presence or absence of a vehicle in the associated parking space. The microcontroller initiates an interrogation station to direct an interrogation signal at the associated parking space in the area of the parking space where the license plate of a parked vehicle is located upon determining the existence of a parking violation.

It is a disadvantage of these conventional pay stations that a collision with a vehicle can damage the pay station housing directly, and any shock resulting therefrom is directly transferred to peripheral devices resulting in irreparable damage.

### BRIEF SUMMARY OF INVENTION

In one aspect of the present invention there is provided a pay station apparatus for parking comprising an enclosure having a plurality of sides, means for controlling operation of the pay station, means for selecting a payment configured with the means for controlling and the enclosure, means for accepting the payment configured with the means for controlling and the enclosure, and a first energy absorbing side panel connected with at least one of the sides of the enclosure.

In another aspect of the present invention, the energy absorbing side panel has signage thereon.

In yet another aspect of the present invention, the energy absorbing side panel protects the pay station from leaks by providing drainage.

It is an advantage of the present invention that energy from a collision with a vehicle is absorbed by the side panels which therefore protects the enclosure and peripheral devices of the pay station.

### BRIEF DESCRIPTION OF DRAWINGS

The invention will be more readily understood from the following description of preferred embodiments thereof given, by way of example only, with reference to the accompanying drawings, in which:

FIG. 1 is an exploded view of a pay station according to one embodiment of the present invention;

FIG. 2 is a front perspective view of the pay station of FIG. 1;

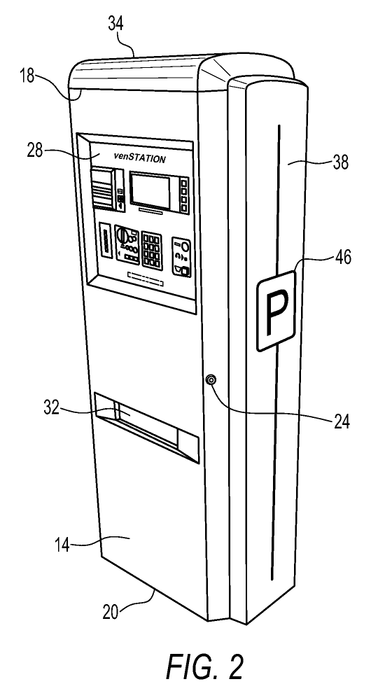

FIG. 3 is a rear perspective view of the pay station of FIG. 1; and

FIG. 4 is a front elevational view of the pay station of FIG. 1.

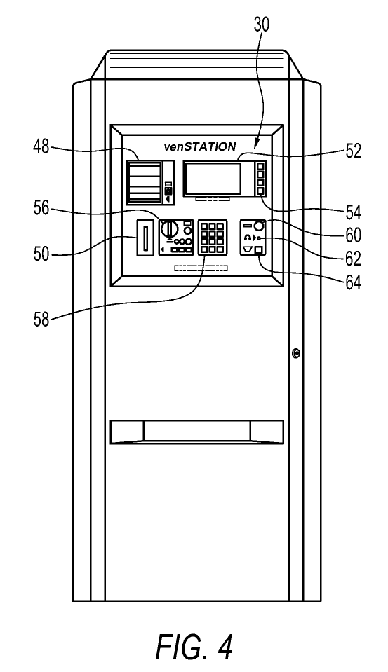

### DESCRIPTION OF THE PREFERRED EMBODIMENTS

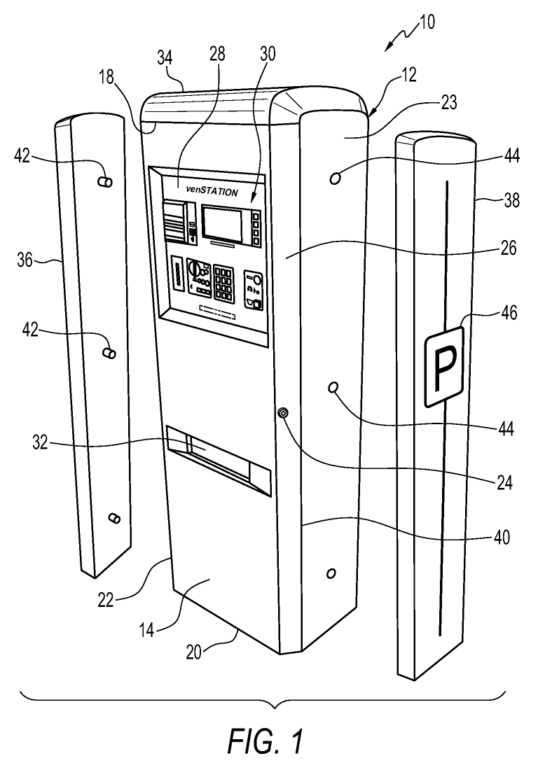

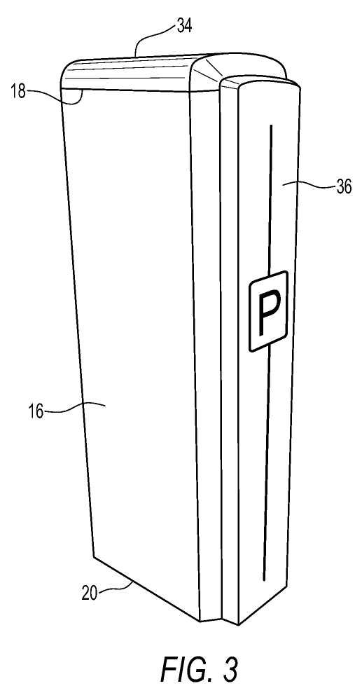

Referring to the figures and first to FIG. 1, there is shown a pay station indicated generally by reference numeral 10 comprising an enclosure 12. The pay station 10 in one embodiment is used for paying for parking and can be located near a street for on street parking, or can be located off street in a parkade, however, other locations for the pay station are possible. The enclosure 12 has a front side 14, a back side 16 (see FIG. 3), a top side 18, a bottom side 20 and opposing left and right sides 22 and 23 respectively.

The front side 14 of the pay station 10 is pivotally connected with the left side 22 by hinges (not shown) and acts as door. There is a lock 24 on bevelled edge 26 for selectively securing the pivotally connected front side 14 with the right side 23 of the enclosure 12. The lock 24 is an electronic lock which is activated by an RF transmitter, e.g. an RFID transmitter, and has a mechanical failsafe for emergency use.

The front side 14 of the enclosure 12 has a recessed surface 28 upon which peripheral devices indicated generally by reference numeral 30, which are described in more detail below, are exposed. There is also a slot 32 for dispensing items, e.g. permits, change, to a user operating the pay station 10.

There is a solar panel 34 on the top side 18 of the enclosure 12 for generating electric power for charging a battery (not shown) and operating the pay station 10. In geographic locations where solar panels are not useable due to environmental conditions, the solar panel 34 can be omitted.

There are detachable side panels 36 and 38 each connected with left and right sides 22 and 23 respectively of the pay station 10. The side panels 36 and 38 have bolts 42 which are received by respective holes 44 in the left and right sides 22 and 23 respectively, and which are then secured by nuts. Alternatively, the side panels can have blind nuts buried therein and bolts can extend from the left and right sides 22 and 23 respectively to secure the panels to the enclosure 12.

The side panels 36 and 38 are energy absorbing side panels and serve to protect the pay station 10, and more particularly the enclosure 12 and peripheral devices 26, from impact during a collision with a car, for example. In other embodiments there can be other energy absorbing side panels connected with other sides of the pay station 10, for example the back side 16.

The side panels are made from an energy absorbing material such as, but not limited to, shock absorbing concrete or rubber. The concrete can comprise fibreglass for reinforcement. The energy from the impact of a collision with an object is substantially absorbed by the side panels, thus protecting the enclosure 12 and peripheral devices 30.

There is a gap 40 between the front side 14 and the right side 23, as best seen in FIG. 1, and a corresponding gap between the front side 14 and the left side 22. The side panels 36 and 38 cover respective gaps when they are connected with the respective sides of the enclosure 12. This provides an additional level of security against an intruder trying to gain forced access to the inside of the enclosure 12 by prying open the front side 14.

Additionally, the side panels 36 and 38 provide added protection to their respective sides 22 and 23 by fortifying against intrusion attacks such as arc welding, drilling and other forced entry methods.

As a further advantage of the side panels 36 and 38, they help protect the pay station 10 against leaking by improving the drainage around the enclosure 12. Furthermore, the side panels 36 and 38 are made from a non-corrosive material as described above.

The side panels 36 and 38 conveniently provide the ability to impress logos and signage 46 on the outer surface thereof, which is an aide for people to recognize where the pay station is located. A mold which is used to form the side panels 36 and 38 can be embossed with the desired signage 46.

The paystation 10 is secured to an under surface, e.g. a sidewalk or parkade floor, by anchoring the enclosure 12 to anchor bolts (not shown) which are secured in the under surface. The anchor bolts can be secured to the under surface by digging a hole therein, adding the anchor bolts and filling the hole with concrete. The anchor bolts can then protrude through holes (not shown) in the bottom side 20 of the enclosure 12, where they are fastened by nuts inside the enclosure.

Referring now to FIG. 3, the peripheral devices 30 include a bill acceptor 48, a card reader 50, a display 52, quick pick push buttons 54, a coin acceptor 56, a keypad 58, a button 60 for canceling transactions, a head phone jack 62 and a pushbutton 64 for requesting audio prompts. In some embodiments, the pay station 10 can include a modem and antenna for wireless communications. In other embodiments, the pay station 10 can include a camera for video communications with the surrounding environment. The media data of the web cam can be stored locally, or can be transmitted to a remote location.

There is also a controller (not shown) inside the enclosure 12 and connected with the peripheral devices 30 for controlling the operation of the peripheral devices 30 and therefore operation of the pay station 10. In addition, there are other conventional items found in pay stations like a coin hopper, a ticket or permit printing device and a power supply.

The display 40, the quick pick push buttons 42, the keypad 46 and the controller enable a user to select a desired payment. The bill acceptor 36, the card reader 38, the coin acceptor 44 and the controller enable a user to make the desired payment. The card reader 38 can be configured to accept credit cards, smart cards and magnetic cards.

As will be apparent to those skilled in the art, modifications can be made to the above-described invention within the scope of the appended claims.

What is claimed is:

1. A pay station apparatus for parking comprising:
an enclosure having a plurality of sides;
means for controlling operation of the pay station;
means for selecting a payment configured with the means for controlling and the enclosure;
means for accepting the payment configured with the means for controlling and the enclosure; and
a first energy absorbing side panel connected with at least one of the sides of the enclosure.

2. The pay station as claimed in claim 1, wherein the energy absorbing side panel is detachable from the enclosure.

3. The pay station as claimed in claim 1, wherein the energy absorbing side panel is a concrete side panel.

4. The pay station as claimed in claim 1, wherein the energy absorbing side panel has signage thereon.

5. The pay station as claimed in claim 1, wherein the energy absorbing side panel protects the pay station from leaks by providing drainage.

6. The pay station as claimed in claim 1, further including a second energy absorbing side panel, wherein the first energy absorbing side panel is connected with a left side of the pay station and the second energy absorbing side panel is connected with a right side of the pay station.

7. The pay station as claimed in claim 3, wherein the concrete is reinforced with fibreglass.

8. The pay station as claimed in claim 1, wherein the energy absorbing side panel has means for fastening embedded therein.

9. The pay station as claimed in claim 8, wherein the fastening means is a bolt.

10. The pay station as claimed in claim 8, wherein the fastening means is a nut.
